(19) United States
(12) Patent Application Publication
(10) Pub. No.: US 2018/0101813 A1
(43) Pub. Date: Apr. 12, 2018

(54) Method and System for Product Data Review

(71) Applicant: Bossa Nova Robotics IP, Inc., Pittsburgh, PA (US)

(72) Inventors: Mark Paat, Pittsburgh, PA (US); Jennifer R. Date, Pittsburgh, PA (US); Julien Eckstrom, Pittsburgh, PA (US)

(21) Appl. No.: 15/716,306

(22) Filed: Sep. 26, 2017

Related U.S. Application Data
(60) Provisional application No. 62/407,375, filed on Oct. 12, 2016.

(51) Int. Cl. G06Q 10/08; H04N 7/18

(52) U.S. Cl. CPC G06Q 10/087; H04N 7/185

(57) ABSTRACT

A system for inventory monitoring includes image capture units to provide images of inventory and a product database to receive inventory images and update changes in product type, number, and placement. A visual tracking application is connected to receive data from the product database. The application has a user interface that supports product management in first mode useful to a single store, and in a second mode useful to a plurality of stores. The first mode provides both a summary chart of product gaps and an image covering a product gap area.

### RELATED APPLICATIONS

This application claims the benefit of U.S. Provisional Application Ser. 62/407,375 filed Oct. 12, 2016, which is hereby incorporated herein by reference in its entirety for all purposes.

### TECHNICAL FIELD

The present disclosure relates generally to a method and system for monitoring store product or inventory data provided by robotic imaging systems. Data visualization techniques are used to provide time critical data to managers.

### BACKGROUND

Retail stores or warehouses can have thousands of distinct products that are often sold, removed, added, or repositioned. Even with frequent restocking schedules, products assumed to be in stock may actually be out of stock, decreasing both sales and customer satisfaction. Point of sales data can be used to roughly estimate product availability, but it lacks accuracy and does not help with identifying misplaced, stolen, or damaged products, all of which can reduce product availability. However, manually monitoring product inventory and tracking product position is expensive, time consuming, and prone to errors.

One use of machine vision systems is shelf space compliance in retail stores or warehouses. For example, large numbers of fixed position cameras can be used throughout a store to monitor aisles. Alternatively, a smaller number of movable cameras can be used to scan a store aisle. Even with such systems, human intervention is often required when resolution is not adequate to determine product identification number or product count.

### SUMMARY

A system for inventory and shelf compliance includes image capture units to provide images and depth data of shelving fixtures and on-shelf inventory and a database to receive inventory images and track inventory state. Inventory state can include, but is not limited to, product type, number, and placement, fixture dimensions, shelf label placement, and pricing, or any other feature or aspect of items. A visual tracking application is connected to receive data from the database (which can be supported, for example, by a local server, or cloud based data service). The application has a user interface that supports product management in a first mode specific to a single store, and in a second mode specific to a plurality of stores. The first mode provides both a summary chart of product gaps and an image covering a product gap area.

In one embodiment, the movable base can be a manually pushed or guidable cart. Alternatively, the movable base can be a tele-operated robot, or in preferred embodiments, an autonomous robot capable of guiding itself through a store or warehouse. Depending on size of the store or warehouse, multiple autonomous robots can be used. Aisles can be regularly inspected to create image-based real time product planograms (i.e. realograms), with aisles having high product movement being inspected more often.

In another embodiment, an inventory monitoring method includes the steps of providing image capture units mounted on autonomous robots to provide images of inventory and create a realogram. The realogram can be used by a product database to support determination of item or inventory state. A user is provided with a visual tracking application connected to receive data from the product database, the application having a user interface that supports product management in first mode specific to a specified store, and a second mode specific to a plurality of stores. The first mode can provide both a summary chart of product gaps and an image covering a product gap area.

Advantageously, the realogram can be used in conjunction with shelf labels, bar codes, and product identification databases to identify products, localize product or label placement, estimate product count, count the number of product facings, or even identify missing products or locate misplaced products. Information can be communicated to a remote server and suitable user interface (e.g. a portable tablet) for use by store managers, stocking employees, or customer assistant representatives. Additionally, the realogram and other information received from other robots, from updated product databases, or from other stores, can be used to update or assist in creation of subsequent realograms. This permits maintenance of a realogram history.

### BRIEF DESCRIPTION OF THE DRAWINGS

FIG. 1 illustrates a system for inventory monitoring;

FIG. 2 illustrates a hierarchy of a suite of application modules or modes that will support visualization of product data;

FIGS. 3A-E illustrate example screenshots of various visualizations;

FIG. 4A is an illustration of a camera system mounted on a movable base to track product changes in aisle shelves or other suitable targets;

FIG. 4B is a cartoon illustrating two autonomous robots inspecting opposite shelves in an aisle; and

FIGS. 5A and B are respectively examples in side view and cross section of an autonomous robot capable of acting as a mobile base for a camera system.

### DETAILED DESCRIPTION

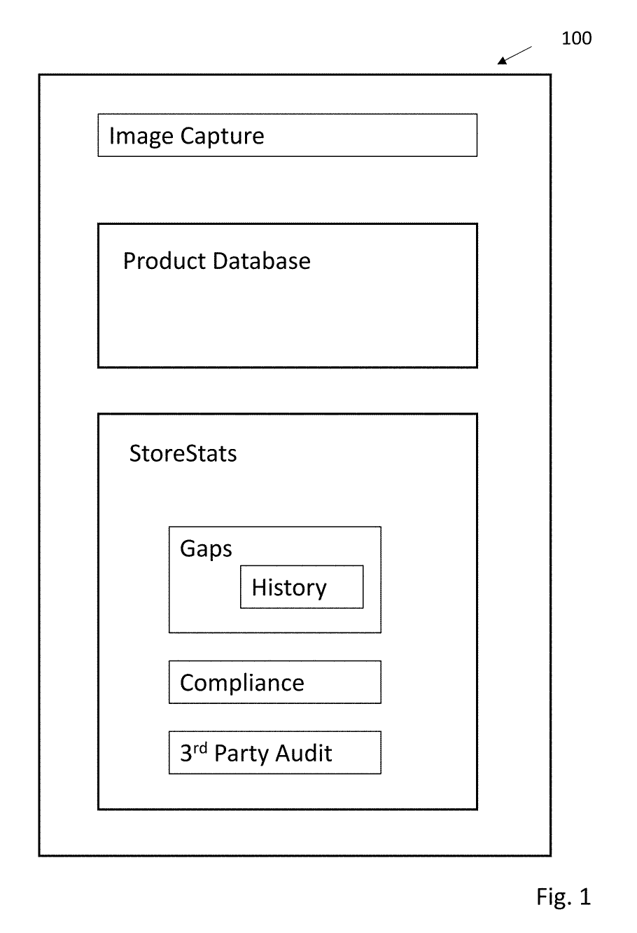

FIG. 1 illustrates a system 100 for inventory or item monitoring. In system 100, image capture units can provide images of inventory to a product database. The image capture units can be supported on a movable base such as manually guidable cart, tele-operated robot, or autonomously operating robot. Based on real time or near-real time images supplied by the image capture units, the product database can update in response to changes in product type, number, and placement.

A visual tracking application (labelled StoreStats in FIG. 1) is connected to receive data from the product database. This visual tracking application has a user interface that supports product management in first mode specific to a single store. This can include inventory monitoring at a store level, by aisle or by section. The first mode can provide both a summary chart of product gaps and an image covering a product gap area. In certain embodiments, a history including a time indexed image covering a selected product gap area, is choosable by a user. Inventory types with special characteristics (e.g. fresh produce or high value items) can be identified in specialized interface screens that provide additional information. Non-image interface presentations are also available. For example, a summary listing missing or low count products is also available.

In addition to the store specific first mode, a second mode specific to a plurality of stores is also available. The second mode further provides an aggregated summary of product gaps in the plurality of stores. In some embodiments, information relating to warehouse or supplier inventory may also be used to facilitate orders for product replenishment.

Other modes can support product or item identification, localization of product or label placement, product count estimation, presenting the number of product facings, or even identify missing products or locate misplaced products productivity tracking. Modes can also allow for determining how long change will take, and for determining suitable times for restocking products (e.g. application notes that restock is available between 3 PM and 7 PM). Product outages can be totaled across the company, or can be compared across departments, stores, other districts in the area. Averages across time can be calculated, permitting improved quality control and identifying superior managers and employees.

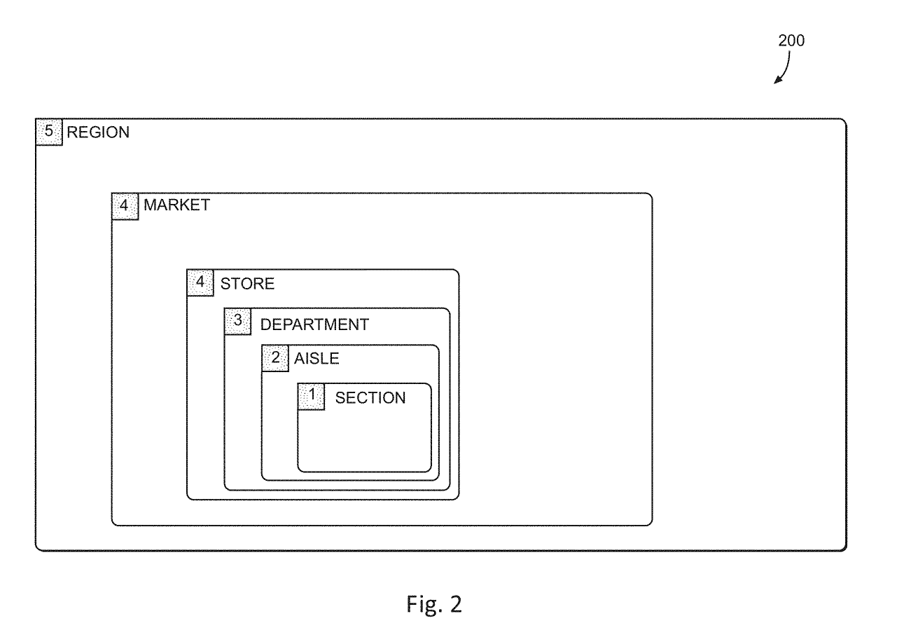

FIG. 2 illustrates a hierarchy 200 of a suite of application modules or modes that will support visualization of product data pertinent to a section, an aisle, a department, a store, a market, a region, or other useful category. Executives can have access to aggregated data across the enterprise with drilldown and filter capabilities. Managers can have store level access to detailed information, allowing them to prioritize associates' work, or view product information aggregated across the entire store. Associates responsible for restocking shelves can be provided with low level store information necessary to identify and prioritize their work. To effectively monitor the systems, data can also be reviewed by the system manufacturer or builder, and associated technicians, and task consultants. In some embodiments, 3^{rd} parties responsible for validation or product identification can be provided access. In still other situations, product manufacturers, wholesalers or advertisers can use the system to check product, signage, and promotions availability and placement.

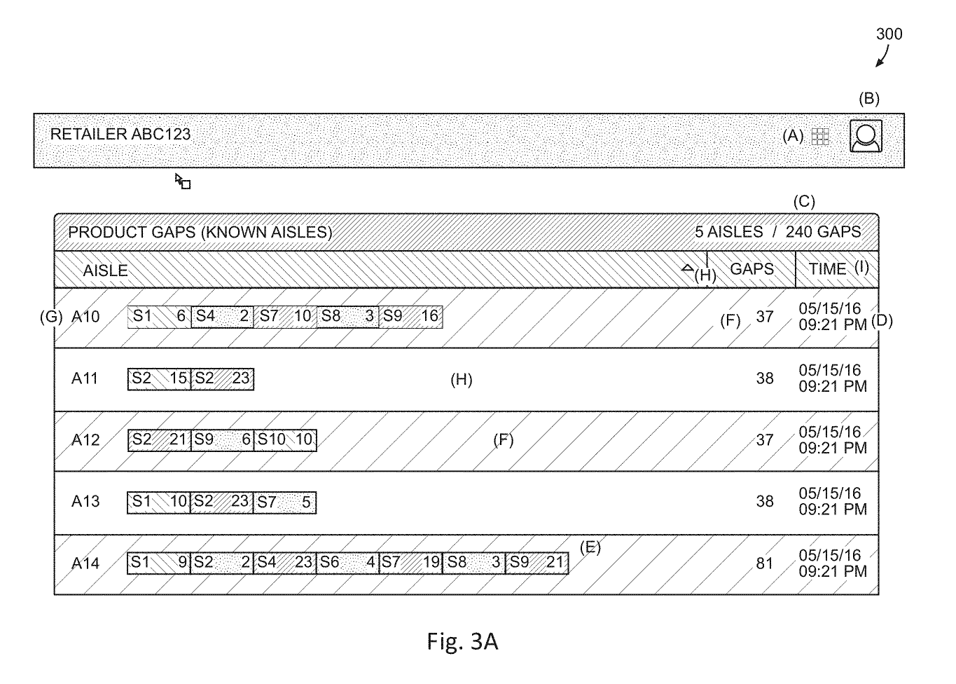

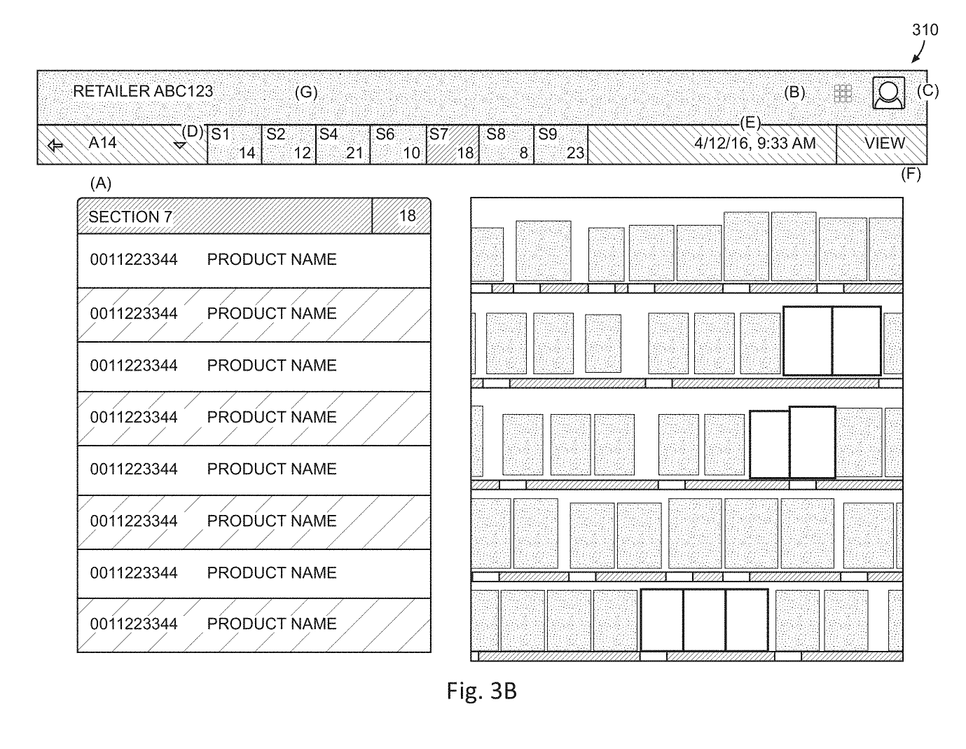

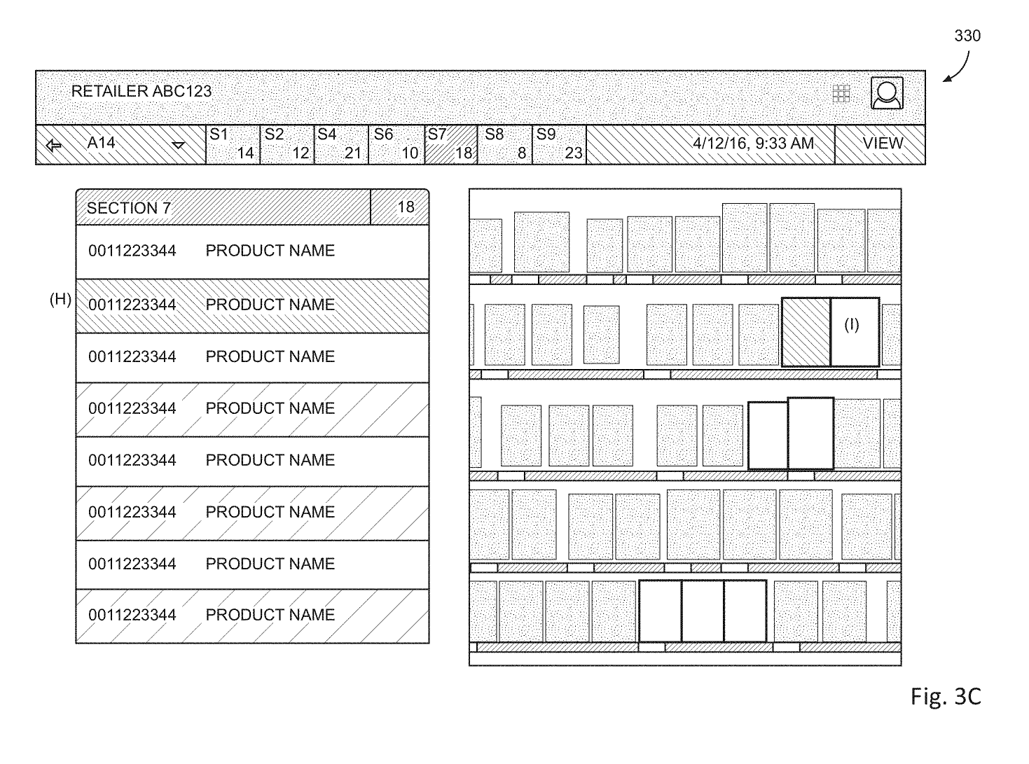

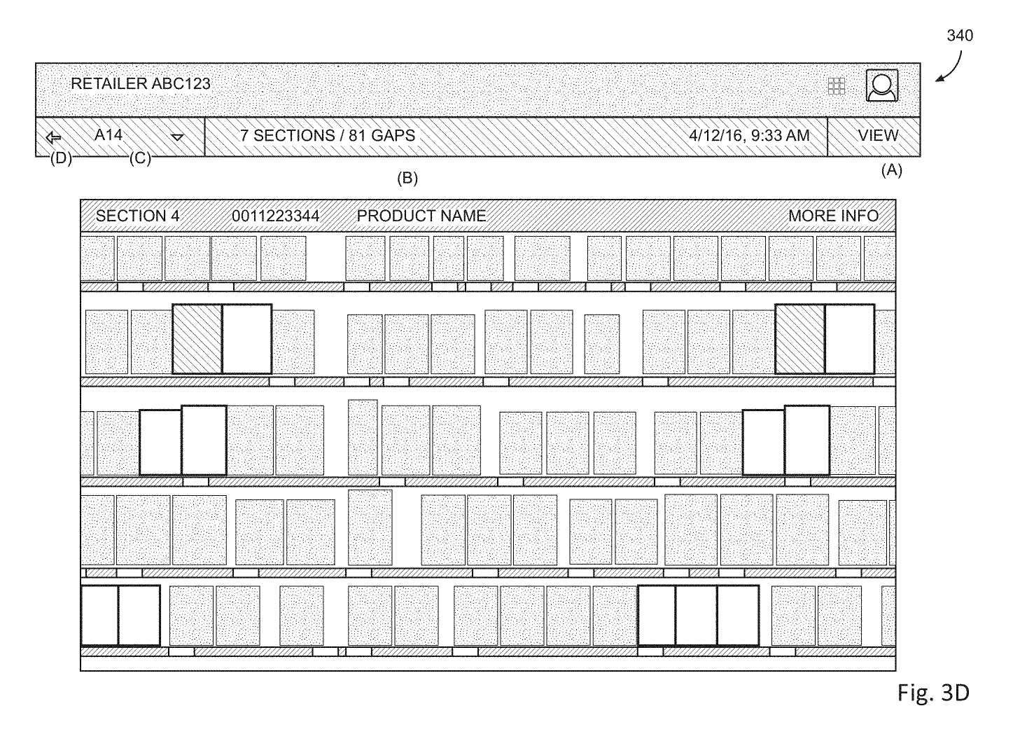

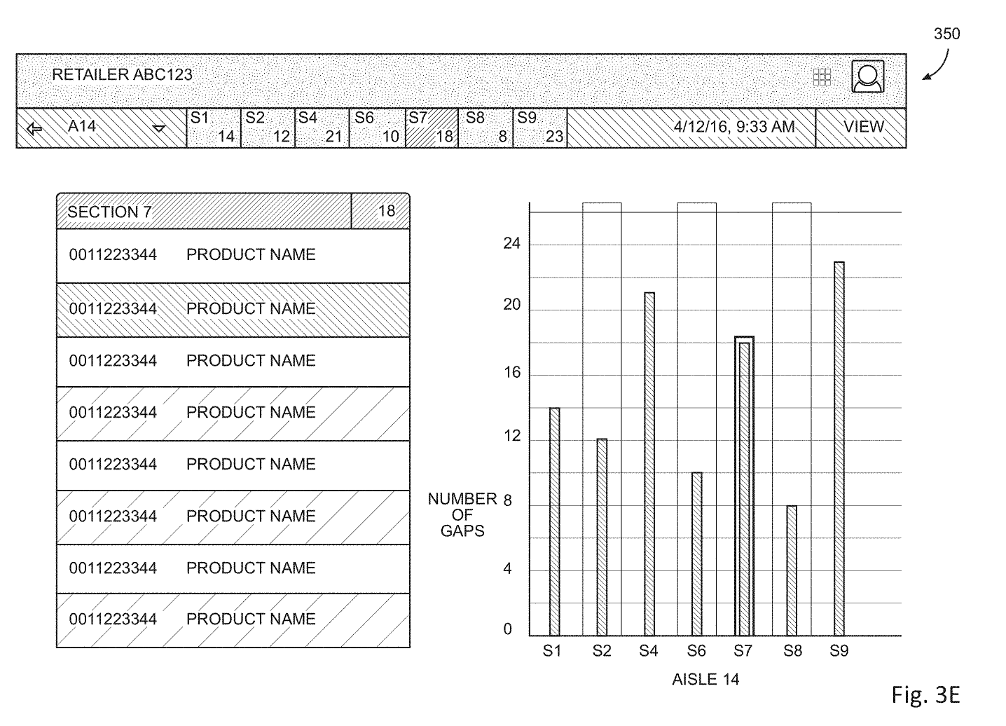

FIG. 3A illustrates a screen visualization 300 suitable for a manager of a single store. At this level of hierarchy, the overall summary of the aisles scanned is shown, with user interface items being identified by parenthesis bracketed capital letters (e.g. “(A)”, “(B)”, etc.) in this FIG. 3A and the following FIGS. 3B-E. A user can navigate to other applications using the app menu (A). A pop up menu appears listing all of the applications available to the user. User can log into (sign-on) the system by tapping his/her avatar (B) that will launch a menu. In this menu are application settings as well as “Sign In” or “Sign Out” menu items”. Text information indicates a total count of aisles, and a total count of gaps (C). The most recent scan date/time for each aisle is also included (D). Each aisle and the sections that make up that aisle will be represented visually. Sections of the aisle with gaps will be colorized and textured. Sections will be colorized and textured according to how many gaps were found. The fewer the gaps, the lighter the parent color; the more gaps found, the darker the parent color. Colors may be augmented by patterns to address color blindness. The count for all sections is included at the far right of each section tile to further communicate data (E). Each aisle communicates a count of gaps (“F”, located at the right side of each aisle graphic). Each section of the aisles chart is interactive, so that when a specific section is selected it will appear in focus/detail on another screen.

The Aisle number is also interactive. Clicking/tapping on an aisle number (G) will take user to another screen with the first section including outs displayed in the table with a matching image. By default, aisles are arranged chronologically. Tapping “Gaps” (H) or “Time” (I) will sort the data by that attribute. When “Gaps” are selected, the data is sorted from highest number of gaps to lowest. When “Time” is selected, the data is sorted newest scan to oldest scan.

FIG. 3B illustrates another screen visualization 310 suitable for a manager of a single store. At this level of hierarchy, a product image is viewable (in this Figure, product images are illustrated as grey boxes or outlined rectangular regions). A manager user can tap/click on a section from the aisles summary chart (discussed with respect to FIG. 3A above) to get to the image page. The tap/click is context sensitive, meaning that the item the user tapped is presented front and center of the screen when a user enters this page. In this example, user tapped on section 7 of Aisle 14 on the aisles summary screen. Here, section 1 is displayed in the image, and the table off to the left displays Section 1. A user can navigate back to the aisles summary screen by using the back button (A) in the far left of the page navigation bar. The user can navigate to other applications using the app menu (B). A pop up menu appears listing all of the applications available to the user. The user can sign out of the system by tapping his/her avatar (C) that will launch a menu. In this menu are settings as well as “Sign out”. Aisles can also be chosen via the dropdown menu (D). The date of the scan is indicated (E). The view of this screen can be altered to a full image view (F).

Sections of an aisle can be chosen by tapping/clicking (G). Section buttons work like bookmarks, with the data displayed in the body of the user interface jumping the user to the selected section. The section navigation bar and table are linked together. Scrolling in the table affects the selection state of the section navigation bar. The image is not linked with the table or section navigation bar.

FIG. 3C illustrates a screen visualization 330 after selecting a product on the list seen in FIG. 3B. The selected product (H) highlights that product gap in the image (I). Alternatively, selecting a product gap in the image will highlight the product in the list.

FIG. 3D illustrates a screen visualization 340 after selecting a product on the list seen in FIG. 3C and triggering a full image view. User switching of the view to the full image view is enabled by tapping the view button (A). This also automatically updates the header information. The section navigation bar is removed and replaced with aisle summary information. The scan date of the aisle is left in place. Now, the header bar at the top of the image (B) displays product info about the selected gap. The image is pannable and zoomable. The user can select other aisles by using the drop down menu (C). User can also return to level one by using the back button (D)

FIG. 3E illustrates a screen visualization 350 of table and bar chart. The bar chart displays gaps across sections of an aisle where products were missing. The bar chart displays one aisle at a time and includes navigation buttons to jump to different aisles. If a different aisle is selected, aisle information in the navigation bar is accordingly adjusted. Each bar in the bar chart is selectable and affects what is displayed in the table to the left.

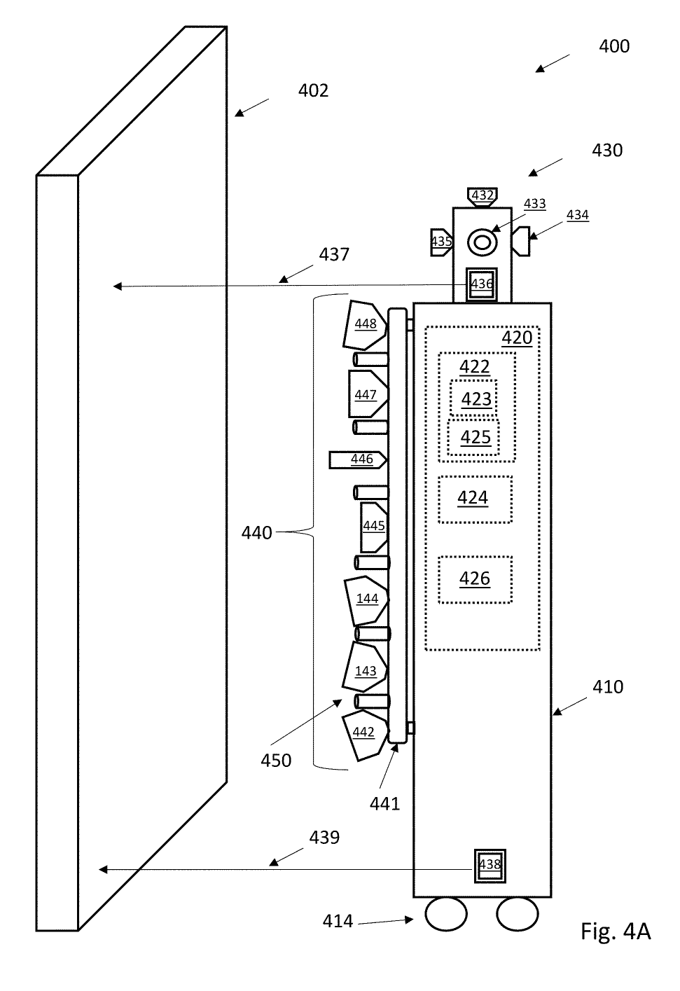

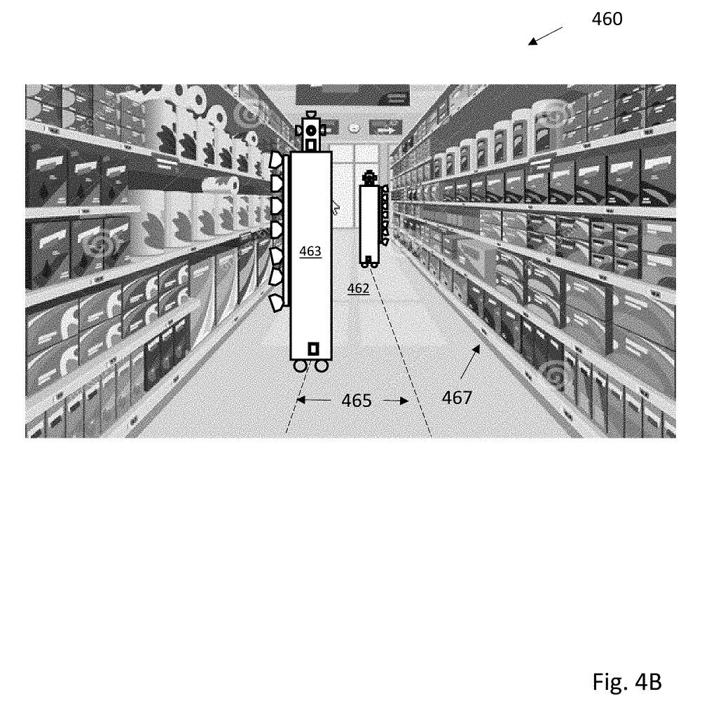

FIG. 4A is an illustration of an inventory monitoring camera system 400 suitable for use in the disclosed method and system for product data review. The inventory monitoring camera system 400 can be mounted on a movable base 410 (with drive wheels 414) to track product changes in aisle shelves or other targets 402. The movable base 410 is an autonomous robot having a navigation and object sensing suite 430 that is capable of independently navigating and moving throughout a building. The autonomous robot has multiple cameras 440 attached to movable base 410 by a vertically extending camera support 440. Lights 450 are positioned near each camera to direct light toward target 402. In some embodiments, the cameras can include one or more movable cameras, zoom cameras, focusable cameras, wide-field cameras, infrared cameras, or other specialty cameras to aid in product identification or image construction, reduce power consumption, and relax the requirement of positioning the cameras at a set distance from shelves. For example, a wide-field camera can be used to create a template into which data from higher resolution cameras with a narrow field of view are mapped. As another example, a tilt controllable, high resolution camera positioned on the camera support can be used to detect shelf labels and their content, including the price and product name, and decode their barcodes.

The object sensing suite includes forward (433), side (434 and 435), top (432) and rear (not shown) image sensors to aid in object detection, localization, and navigation. Additional sensors such as laser ranging units 436 and 438 (and respective laser scanning beams 437 and 439) also form a part of the sensor suite that is useful for accurate distance determination. In certain embodiments, image sensors can be depth sensors that project an infrared mesh overlay that allows estimation of object distance in an image, or that infer depth from the time of flight of light reflecting off the target. In other embodiments, simple cameras and various image processing algorithms for identifying object position and location can be used. For selected applications, ultrasonic sensors, radar systems, magnetometers or the like can be used to aid in navigation. In still other embodiments, sensors capable of detecting electromagnetic, light, or other location beacons can be useful for precise positioning of the autonomous robot.

The inventory monitoring camera system 400 is connected to an onboard processing module that is able to determine item or inventory state. This can include but is not limited to constructing from the camera derived images an updateable inventory map with product name, product count, or product placement. Because it can be updated in real or near real time, this map is known as a “realogram” to distinguish from conventional “planograms” that take the form of 3D models, cartoons, diagrams or lists that show how and where specific retail products and signage should be placed on shelves or displays. Realograms can be locally stored with a data storage module connected to the processing module. A communication module can be connected to the processing module to transfer realogram data to remote locations, including store servers or other supported camera systems, and additionally receive inventory information including planograms to aid in realogram construction. Inventory data can include but is not limited to an inventory database capable of storing data on a plurality of products, each product associated with a product type, product dimensions, a product 3D model, a product image and a current product shelf inventory count and number of facings. Realograms captured and created at different times can be stored, and data analysis used to improve estimates of product availability. In certain embodiments, frequency of realogram creation can be increased or reduced, and changes to robot navigation being determined.

In addition to realogram mapping, this system can be used to detect out of stock products, estimate depleted products, estimate amount of products including in stacked piles, estimate products heights, lengths and widths, build 3D models of products, determine products' positions and orientations, determine whether one or more products are in disorganized on-shelf presentation that requires corrective action such as facing or zoning operations, estimate freshness of products such as produce, estimate quality of products including packaging integrity, locate products, including at home locations, secondary locations, top stock, bottom stock, and in the backroom, detect a misplaced product event (also known as a plug), identify misplaced products, estimate or count the number of product facings, compare the number of product facings to the planogram, estimate label locations, detect label type, read label content, including product name, barcode, UPC code and pricing, detect missing labels, compare label locations to the planogram, compare product locations to the planogram, measure shelf height, shelf depth, shelf width and section width, recognize signage, detect promotional material, including displays, signage, and features and measure their bring up and down times, detect and recognize seasonal and promotional products and displays such as product islands and features, capture images of individual products and groups of products and fixtures such as entire aisles, shelf sections, specific products on an aisle, and product displays and islands, capture 360-deg and spherical views of the environment to be visualized in a virtual tour application allowing for virtual walk throughs, capture 3D images of the environment to be viewed in augmented or virtual reality, capture environmental conditions including ambient light levels, capture information about the environment including determining if light bulbs are off, provide a real-time video feed of the space to remote monitors, provide on-demand images and videos of specific locations, including in live or scheduled settings, and build a library of product images.

In addition to product and inventory related items, the disclosed system can be used for security monitoring. Items can be identified and tracked in a range of buildings or environments. For example, presence or absence of flyers, informational papers, memos, other documentation made available for public distribution can be monitored. Alternatively, position and presence of items in an office building, including computers, printers, laptops, or the like can be monitored.

Because of the available high precision laser measurement system, the disclosed system can be used facilitate tracking of properties related to distances between items or furniture, as well as measure architectural elements such as doorways, hallways or room sizes. This allows verification of distances (e.g. aisle width) required for applicable fire, safety, or Americans with Disability Act (ADA) regulations. For example, if a temporary shelving display blocks a large enough portion of an aisle to prevent passage of wheelchairs, the disclosed system can provide a warning to a store manager. Alternatively, high precision measurements of door sizes, width or slope of wheelchair access pathways, or other architectural features can be made.

As previously noted, a realogram can use camera derived images to produce an updateable map of product or inventory position. Typically, one or more shelf units (e.g. target 402) would be imaged by a diverse set of camera types, including downwardly (442 and 444) or upwardly (443 and 448) fixed focal length cameras that cover a defined field less than the whole of a target shelf unit; a wide field camera 445 to provide greater photographic coverage than the fixed focal length cameras; and a narrow field, zoomable telephoto 446 to capture bar codes, product identification numbers, and shelf labels. Alternatively, a high resolution, tilt controllable camera can be used to identify shelf labels. These camera 440 derived images can be stitched together, with products in the images identified, and position determined.

To simplify image processing and provide accurate results, the multiple cameras are typically positioned a set distance from the targeted shelves during the inspection process. The shelves can be illuminated with LED or other directable lights 450 positioned on or near the cameras. The multiple cameras can be linearly mounted in vertical, horizontal, or other suitable orientation on a camera support. In some embodiments, to reduce costs, multiple cameras are fixedly mounted on a camera support. Such cameras can be arranged to point upward, downward, or level with respect to the camera support and the shelves. This advantageously permits a reduction in glare from products having highly reflective surfaces, since multiple cameras pointed in slightly different directions can result in at least one image with little or no glare.

Electronic control unit 420 contains an autonomous robot sensing and navigation control module 424 that manages robot responses. Robot position localization may utilize external markers and fiducials, or rely solely on localization information provided by robot-mounted sensors. Sensors for position determination include previously noted imaging, optical, ultrasonic sonar, radar, Lidar, Time of Flight, structured light, or other means of measuring distance between the robot and the environment, or incremental distance traveled by the mobile base, using techniques that include but are not limited to triangulation, visual flow, visual odometry and wheel odometry.

Electronic control unit 420 also provides image processing using a camera control and data processing module 422. Autonomous robot sensing and navigation control module 424 manages robot responses, and communication module 426 manages data input and output. The camera control and data processing module 422 can include a separate data storage module 423 (e.g. solid state hard drives) connected to a processing module 425. The communication module 426 is connected to the processing module 425 to transfer realogram data to remote server locations, including store servers or other supported camera systems, and additionally receive inventory information to aid in realogram construction. In certain embodiments, realogram data is primarily stored and images are processed within the autonomous robot. Advantageously, this reduces data transfer requirements, and permits operation even when local or cloud servers are not available.

FIG. 4B is a cartoon 460 illustrating two autonomous robots 462 and 463, similar to that discussed with respect to FIG. 4A, inspecting opposite shelves 467 in an aisle. As shown, each robot follows path 465 along the length of an aisle, with multiple cameras capturing images of the shelves 467 while using the previously discussed glare reduction method and system.

In some embodiments, the robots 462 and 463 support at least one range finding sensor to measure distance between the multiple cameras and the shelves and products on shelves, with an accuracy between about 5 cm and 4 mm. This can be used to improve illumination estimates, as well as for robot navigation. Using absolute location sensors, relative distance measurements to the shelves, triangulation to a known landmark, conventional simultaneous localization and mapping (SLAM) methodologies, or relying on beacons positioned at known locations in a blueprint or a previously built map, the robots 462 and 463 can move along a path generally parallel to a shelves 467. As the robots move, vertically positioned cameras are synchronized to simultaneously capture images of the shelves 467.

In certain embodiments, a depth map of the shelves and products is created by measuring distances from the shelf cameras to the shelves and products over the length of the shelving unit using a laser ranging system, an infrared depth sensor, or similar system capable of distinguishing depth at a centimeter or less scale. Consecutive depth maps as well as images are simultaneously taken to span an entire aisle or shelving unit. The images can be first stitched vertically among all the cameras, and then horizontally and incrementally stitched with each new consecutive set of vertical images as the robots 462 and 463 move along an aisle. These images, along with any depth information, are stitched together. Once a stitched image has been created, a realogram based on or derived from the composite depth map and stitched image and suitable for product mapping can be created or updated.

The communication system can include connections to both a wired or wireless connect subsystem for interaction with devices such as servers, desktop computers, laptops, tablets, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols. In one particular embodiment, multiple communication systems can be provided. For example, a direct Wi-Fi connection (802.11b/g/n) can be used as well as a separate 4G cellular connection.

Remote servers can include, but are not limited to servers, desktop computers, laptops, tablets, or smart phones. Remote server embodiments may also be implemented in cloud computing environments. Cloud computing may be defined as a model for enabling ubiquitous, convenient, on-demand network access to a shared pool of configurable computing resources (e.g., networks, servers, storage, applications, and services) A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Realogram updating can begin when a robot moves to an identified position and proceeds along an aisle path at a predetermined distance. If the path is blocked by people or objects, the robot can wait till the path is unobstructed, begin movement and slow down or wait as it nears the obstruction, move along the path until required to divert around the object before reacquiring the path, or simply select an alternative aisle.

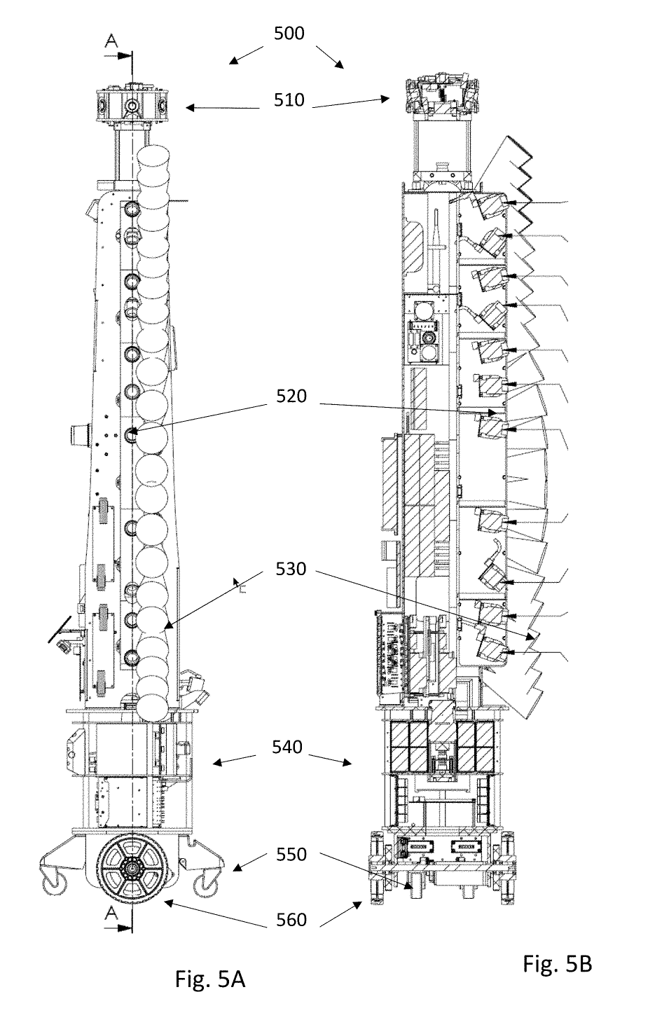

FIGS. 5A and B are respectively examples in side view and cross section of an autonomous robot 500 capable of acting as a mobile base for a camera system in accordance with this disclosure. The robot navigation and sensing unit includes a top mount sensor module 510 with a number of forward, side, rear, and top mounted cameras. A vertically aligned array of lights 520 is sited next to a vertically arranged line of cameras 530, and both are supported by a drive base 540 that includes control electronics, power, and docking interconnects. Mobility is provided by drive wheels 560, and stability is improved by caster wheels 550.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

What is claimed is:

1. A system for inventory monitoring, comprising:
an image capture unit operated to provide images of inventory;
a product database to receive inventory images and track inventory state;
a visual tracking application connected to receive data from the product database, the application having a user interface that supports product management in first mode specific to a single store, and a second mode specific to a plurality of stores; and
wherein the first mode provides both a summary chart of product gaps and an image covering a product gap area.

2. The system of claim 1, wherein the first mode further provides a summary listing of missing or low count products.

3. The system of claim 1, wherein the first mode further provides a history, with a time indexed image covering a product gap area being choosable by a user.

4. The system of claim 1, wherein the second mode further provides an aggregated summary of product gaps in the plurality of stores.

5. The system of claim 1, wherein the product database is locally executed on the image capture unit.

6. The system of claim 1, wherein the image capture unit is supported on a movable base.

7. The camera system of claim 1, wherein the movable base further comprises an autonomous robot.

8. A inventory monitoring method, comprising the steps of:
providing an image capture unit mounted on autonomous robot to provide images of inventory and locally create a realogram used by a product database that supports tracking of inventory state;
providing a user with a visual tracking application connected to receive data from the product database, the application having a user interface that supports product management in first mode specific to a specified store, and a second mode specific to a plurality of stores; and
wherein the first mode provides both a summary chart of product gaps and an image covering a product gap area.

9. A inventory monitoring method, comprising the steps of:
providing an image capture unit mounted on an autonomous robot that moves along an aisle and captures multiple images stitchable into a panoramic view of inventory, locally creating a realogram used by a product database that supports updating of inventory state;
providing a user with a visual tracking application connected to receive data from the product database, the application having a user interface that supports product management in first mode specific to a specified store, and a second mode specific to a plurality of stores; and
wherein the first mode provides both a summary chart of product gaps and an image covering a product gap area.

10. A monitoring system, comprising:
an image capture unit operated to provide images of items;
a database to receive images and track item state;
a visual tracking application connected to receive data from the item database, the application having a user interface that supports item management and measurement of distances related to an item.

11. The system of claim 10, wherein the image capture unit is mounted on an autonomous robot, and the database is locally executed on the image capture unit.
